(19) United States
(12) Patent Application Publication
(10) Pub. No.: US 2013/0138024 A1
(43) Pub. Date: May 30, 2013

(54) MASSAGE DEVICE

(71) Applicant: Tom Jennings, Indianapolis, IN (US)

(72) Inventor: Tom Jennings, Indianapolis, IN (US)

(21) Appl. No.: 13/751,431

(22) Filed: Jan. 28, 2013

Related U.S. Application Data
(63) Continuation of application No. PCT/US2011/047025, filed on Aug. 9, 2011.
(60) Provisional application No. 61/371,883, filed on Aug. 9, 2010.

(51) Int. Cl. A61H 15/00

(52) U.S. Cl. CPC A61H 15/0092
USPC 601/119

(57) ABSTRACT

Disclosed in some embodiments are unique massage devices that incorporate a generally disk-shaped member. In some preferred forms, the disk-shaped member will have an outer annular surface for contacting and massaging the body of a massage recipient, and the outer annular surface will have a variable width around the disk-shaped member. While this outer annular surface might be provided by an individual object (e.g., a molded rubber member), in some preferred forms, the outer annular surface will be provided by two or more constituent pieces that have been united to form a full outer annular surface. The invention also provides methods for constructing and using such massage devices.

### CROSS-REFERENCE TO RELATED APPLICATIONS

This application is a continuation of International Patent Application No. PCT/US2011/047025, filed Aug. 9, 2011, which claims the benefit of U.S. Provisional Patent Application No. 61/371,883 filed Aug. 9, 2010, which are hereby incorporated by reference.

### BACKGROUND

The present invention relates generally to massage devices, and in particular aspects to massage devices that incorporate a disk-shaped member having an outer annular surface for contacting and massaging the body of a massage recipient where the outer annular surface has a varying width around the disk-shaped member.

As further background, several massage devices have been developed including some that incorporate a disk or disk-like member. Nevertheless, there remain needs for improved and/or alternative massage devices, as well as methods for preparing and utilizing the same. The present invention is addressed to those needs.

### SUMMARY

The present invention provides, in certain aspects, unique massage devices that incorporate a disk-shaped member for contacting and massaging the body of a massage recipient. Illustratively, in one inventive embodiment, such a disk-shaped member has an exterior that includes a left side face opposite a right side face. Each of the faces has a perimeter, and an intermediate, annular surface is located generally between these perimeters. The width of the intermediate surface varies around the disk-shaped member. In some forms, the perimeter of the left side face opposes the perimeter of the right side face in a symmetrical fashion around the disk-shaped member. Optionally, the device can incorporate at least one handle, e.g., a first handle extending from the left side face of the disk-shaped member and/or a second handle extending from the right side face of the disk-shaped member. When equipped with a handle, the disk-shaped member can be rotatable with respect to the handle.

In another aspect, the invention provides a massage device comprising a disk-shaped member. This disk-shaped member includes a generally annular exterior surface for contacting and massaging the body of a massage recipient. The annular exterior surface has a left circumferential side edge and a right circumferential side edge, and the distance between the left circumferential side edge and the right circumferential side edge varies around the annular exterior surface. In some preferred forms, the distance between the left circumferential side edge and the right circumferential side edge will change from a first distance to a second distance and back to the first distance at least once around the disk-shaped member. In an illustrative construction, this first distance will be a maximum distance between the left circumferential side edge and the right circumferential side edge, and the second distance will be a minimum distance between the left circumferential side edge and the right circumferential side edge. While not necessary to broader aspects of this device, in some forms, the annular exterior surface will be convexly shaped in a lateral direction across the disk-shaped member. Optionally, the disk-shaped member can include at least one projection extending from the annular exterior surface. Illustratively, the at least one projection might be a circumferential ridge that extends around the disk-shaped member between the left circumferential side edge and the right circumferential side edge of the annular exterior surface. In some instances, a ridge or ridge-like projection that runs in a generally longitudinal direction around the annular exterior surface (e.g., extending fully or partially around the disk-shaped member) will provide a circumferential side edge of the annular exterior surface.

Another embodiment of the present invention provides a massage device which comprises a generally disk-shaped member that includes an outer annular surface for contacting and massaging the body of a massage recipient, with the outer annular surface having a variable width around the disk-shaped member. While this outer annular surface might be provided by a single device component (e.g., a molded plastic or rubber member), in some preferred forms, the outer annular surface will be provided by two or more constituent components that have been joined together to form the outer annular surface.

Yet another aspect of the invention provides a massage device which comprises a disk-shaped member having a left side edge with a circumference, a right side edge with a circumference, and a generally annular exterior surface that extends around the disk-shaped member between the left side edge and the right side edge. The distance between the left side edge and the right side edge varies around the disk-shaped member. In one preferred form, at least one of the left side edge and the right side edge will extend around the disk-shaped member in an undulating fashion. For example, the left side edge and the right side edge might both undulate around the disk-shaped member in a symmetrical fashion. In this and other forms, optionally, the left side edge and the right side edge might undulate one or more times around the disk-shaped member between a maximum width of the annular exterior surface and a minimum width of the annular exterior surface.

Other objects, embodiments, forms, features, advantages, aspects, and benefits of the present invention shall become apparent from the detailed description and drawings included herein.

### BRIEF DESCRIPTION OF THE DRAWINGS

FIG. 1A is a front view of a massage device including a disk-shaped member according to one embodiment of the present invention.

FIG. 1B is a perspective view of the massage device of FIG. 1A.

FIG. 2 is a diagram showing how the width of an intermediate surface of the disk-shaped member of FIGS. 1A-B varies around the disk-shaped member.

FIG. 3 is a diagram showing how the width of a generally annular-shaped outer surface of another illustrative disk-shaped member varies around the disk-shaped member.

FIG. 4 is an exploded view of a disk-shaped member according to another embodiment of the present invention.

FIG. 5 is a diagram showing how the width of an outer surface of a partial disk-shaped member in accordance with the present invention varies around the partial disk-shaped member.

FIG. 6 is a diagram showing how the width of an outer surface of another illustrative partial disk-shaped member varies around the partial disk-shaped member.

FIG. 7 is an exploded view of a disk-shaped member according to another embodiment of the present invention.

FIG. 8 is a front view of a massage device according to another embodiment of the present invention.

FIG. 9 is a perspective view of a massage device according to another embodiment of the present invention.

### DETAILED DESCRIPTION

While the present invention may be embodied in many different forms, for the purpose of promoting an understanding of the principles of the present invention, reference will now be made to the embodiments illustrated in the drawings, and specific language will be used to describe the same. It will nevertheless be understood that no limitation of the scope of the invention is thereby intended. Any alterations and further modifications in the described embodiments and any further applications of the principles of the present invention as described herein are contemplated as would normally occur to one skilled in the art to which the invention relates.

As disclosed above, in certain aspects, the present invention provides unique massage devices that incorporate a generally disk-shaped member. In some preferred forms, the disk-shaped member will have an outer annular surface for contacting and massaging the body of a massage recipient, and the outer annular surface will have a variable width around the disk-shaped member. While this outer annular surface might be provided by an individual object (e.g., a piece of wood or a molded plastic member), in some preferred forms, the outer annular surface will be provided by two or more constituent pieces that have been united to form a combined outer annular surface. The invention also provides methods for constructing and using such massage devices.

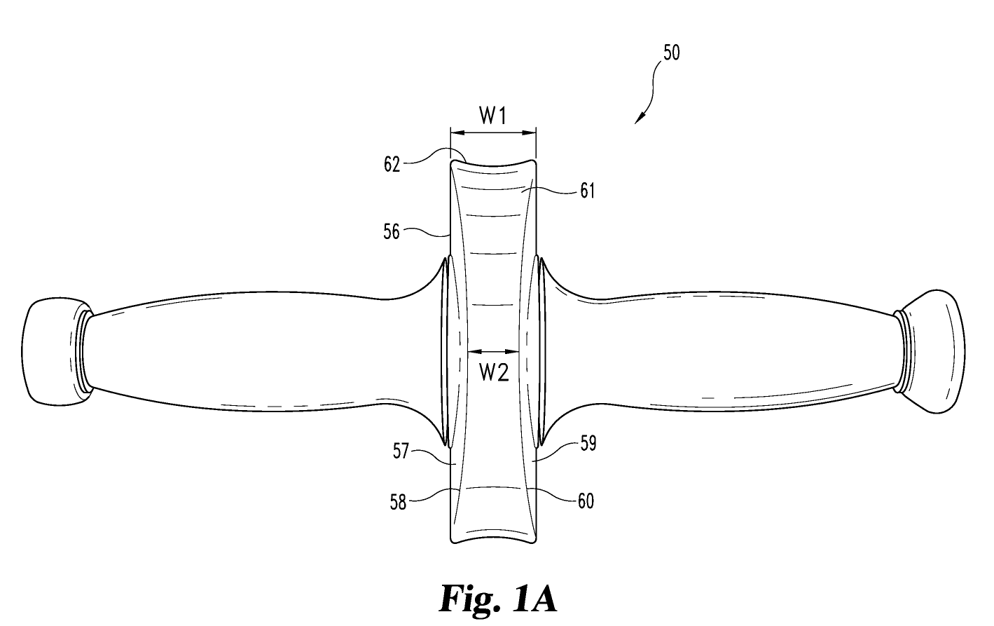

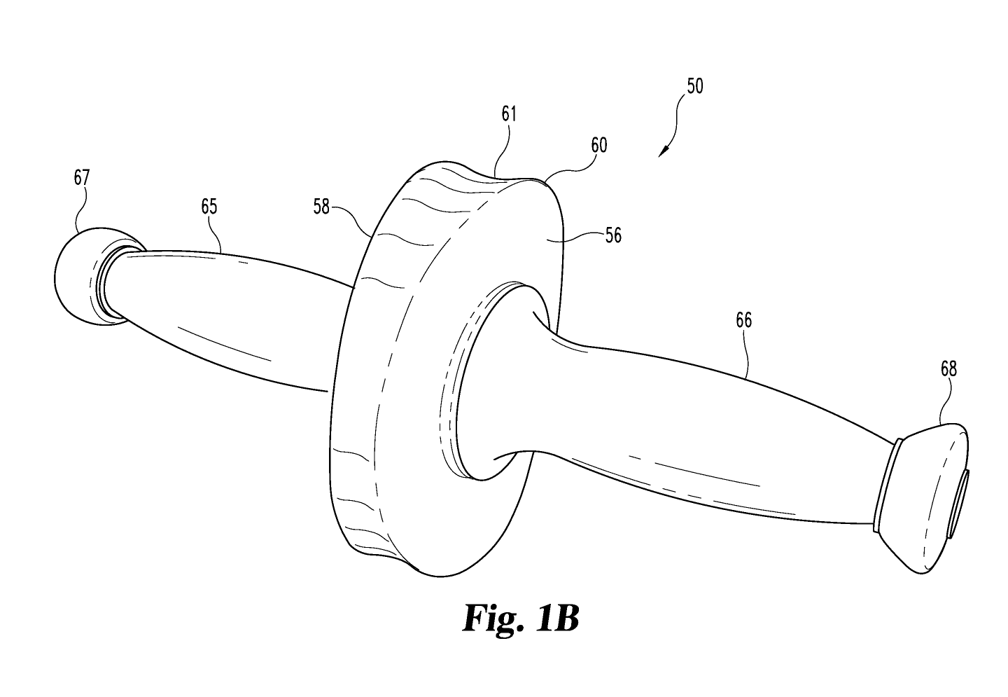

With reference now to FIGS. 1A-B, shown is a massage device 50 according to one embodiment of the present invention. In FIG. 1A, a front view of device 50 shows that it includes a generally disk-shaped member 56 which is useful for contacting and massaging the body of a massage recipient. Disk-shaped member 56 has an exterior that includes a left side face 57 with a perimeter 58, and a right side face 59 with a perimeter 60. The faces are generally opposite one another, and the disk-shaped member includes an intermediate, annular surface 61 that is located generally between the perimeters of the two faces. While not necessary to broader aspects of the invention, in this particular illustrative embodiment, discernible left and right edges of the intermediate surface are formed where the intermediate surface comes together with the left side face and the right side face, respectively. When an edge or edge-like feature is formed in such a manner, it can be generally angular in shape or it can be rounded off to some extent. In some other embodiments, a lesser- or non-discernible edge region will be formed. Such a disk-shaped member will have a general diameter in the range of about 1.5 inches to about 12 inches although disk-shaped members having larger and smaller diameters are contemplated. In some preferred forms, a disk-shaped member will generally have a diameter in the range of about 2 inches to about 8 inches. In some other preferred forms, a disk-shaped member will generally have a diameter in the range of about 3 inches to about 6 inches. A particularly preferred disk-shaped member will generally have a diameter in the range of about 4 inches to about 5 inches.

Continuing with FIG. 1A, the width of the intermediate surface 61 varies around the disk-shaped member 56, and from this view it can be seen that the left and right sides of the intermediate surface 61 are bilaterally symmetrical, and that the width of the intermediate surface 61 fluctuates in an undulating fashion around the disk-shaped member 56 (i.e., fluctuating between a maximum width W1 and a minimum width W2). In particular, in this illustrative embodiment, the width of the intermediate surface 61 attains the maximum width W1 and the minimum width W2 twice during one full revolution around the disk-shaped member. The outer surfaces of the left side face 57 and the right side face 59 are gently curved or contoured to accommodate the fluctuating width of the annular surface 61. While not necessary to broader aspects of the invention, in this instance, the intermediate surface 61 exhibits a concave shape 62 in a lateral direction (i.e., left to right when viewed from the front as in FIG. 1A) across the disk-shaped member 56. Alternatively, the intermediate surface might exhibit a convex or flat shape in a lateral direction across the disk-shaped member 56, or any number of other suitable curvilinear or rectilinear shapes in this regard. As discussed herein below, projections of various shapes and sizes will be incorporated into massaging surfaces in some embodiments.

Referring now to FIG. 1B, massage device 50 also includes a first handle 65 extending from the left side face 57 of the disk-shaped member 56, and a second handle 66 extending from the right side face 59 of the member. While handles of this particular shape and construction are certainly useful in this illustrative embodiment, when an inventive device incorporates one or more handles, a handle can be shaped and configured in a variety of manners and can be formed with one or more of a variety of materials (e.g., having a neoprene or other synthetic rubber outer surface). In this particular illustrative embodiment, disk-shaped member 56 is rotatable with respect to the handles although inventive devices with non-rotatable disk-shaped members fall within the scope of the present invention. Additionally, a first rotatable wheel 67 is located at the outside end of first handle 65, and a second rotatable wheel 68 is located at the outside end of second handle 66. These types of wheels can be shaped and configured in variety of manners. In this illustrative embodiment, first wheel 67 is substantially cylindrical but has a slightly concave shape in a lateral direction across the wheel, while second wheel 68 is generally tapered or conical in shape.

An inventive device, or any portion thereof, can be formed with one or more of a variety of materials including those that incorporate or are formed with various types of wood, glass, ceramic, plastic and/or metallic materials. Suitable synthetic polymers include but are not limited to polytetrafluoroethylene (PTFE) (including expanded PTFE), polyethylene terephthalate (PET), polyurethanes, silicones, and polyesters and other polymers such as, but not limited to, polyolefins, polyisobutylene and ethylene-alphaolefin copolymers; acrylic polymers and copolymers, vinyl halide polymers and copolymers, such as polyvinyl chloride; polyvinyl ethers, such as polyvinyl methyl ether; polyvinylidene halides, such as polyvinylidene fluoride and polyvinylidene chloride; polyacrylonitrile, polyvinyl ketones; polyvinyl aromatics, such as polystyrene, polyvinyl esters, such as polyvinyl acetate; copolymers of vinyl monomers with each other and olefins, such as ethylene-methyl methacrylate copolymers, acrylonitrile-styrene copolymers, ABS resins, and ethylene-vinyl acetate copolymers; polyamides, such as Nylon 66 and polycaprolactam; alkyd resins, polycarbonates; polyoxymethylenes; polyimides; polyethers; epoxy resins, polyurethanes; rayon; and rayon-triacetate. Suitable device components may be rigid, malleable, semi-flexible, or flexible.

The diagram in FIG. 2 represents one full revolution around the disk-shaped member 56, and shows how the width of intermediate surface 61 varies around the member. Accordingly, the top of the diagram represents a starting location along the intermediate surface 61 for measuring its width between the perimeter 58 of left side face 57 and the perimeter 60 of right side face 59. At the top of the diagram, the width of the intermediate surface is at a minimum of 0.8 inches (W2). Moving down the diagram (and thus around the disk-shaped member), the width of the intermediate surface increases from 0.8 inches (W2) to a maximum width of 1.2 inches (W1). Along this stretch, notice that an inflection point occurs along each of the peripheral edges (corresponding to the perimeters 58 and 60 of the side faces) of the intermediate surface. Continuing down the diagram, the width of intermediate surface decreases from W1 back to the minimum width of W2 (0.8 inches). Continuing down the diagram from the half-way point, the width of intermediate surface increases from 0.8 inches back to 1.2 inches, and then decreases again from 1.2 inches to 0.8 inches as the bottom of the diagram is reached and one full trip around the disk-shaped member has been completed. By having such a variable-width outer annular surface, a single disk-shaped member can be used, for example, to apply different forms of contact to a single bodily region, and/or it can be used to apply the same form or different forms of contact across multiple bodily regions.

Illustratively, a patient might have a first bodily region expected to benefit from repeated back and forth contact with a first region of the disk-shaped member (e.g., at and around W1), and a second bodily region expected to benefit from repeated back and forth contact with a second region of the disk-shaped member (e.g., at and around W2). In this regard, the user (i.e., the patient or a person administering the treatment to the patient) could perform both massage tasks with the single massage device 50. In another illustrative example, a user might focus on a single body part or region. Initially, the user might use a first region of the disk-shaped member (e.g., at and around W1) to repeatedly massage a body part. Thereafter, the user might switch to using a second region of the disk-shaped member (e.g., at and around W2) to repeatedly massage that same body part. These are just some of the many types of uses that are possible with the devices and products described herein.

In an alternative embodiment, the width of the intermediate surface could increase from a minimum of about 0.8 inches to a maximum of about 1.2 inches and then back to the minimum of about 0.8 inches during one full trip around the disk-shaped member. In still a further embodiment, the width of the intermediate surface could increase from a minimum of about 0.4 inches to a maximum of about 0.8 inches and then back to the minimum of about 0.4 inches during one full trip around the disk-shaped member, or during one-half, one-third, one-fourth, one-fifth or one-sixth trip around the disk-shaped member.

Such an intermediate surface or other similar massaging surface will generally have widths in the range of about 0.1 inches to about 6 inches although massaging surfaces having larger and smaller widths are contemplated. In some preferred forms, a generally annular-shaped or other massaging surface will generally have widths in the range of about 0.2 inches to about 3 inches. In some other preferred forms, a generally annular-shaped or other massaging surface will generally have widths in the range of about 0.3 inches to about 2 inches. In still some other preferred forms, a generally annular-shaped or other massaging surface will generally have widths in the range of about 0.4 inches to about 1.5 inches. In even further embodiments, a generally annular-shaped or other massaging surface will generally have widths in the range of about 0.6 inches to about 1.4 inches. A particularly preferred generally annular-shaped or other massaging surface will have widths in the range of about 1.0 inches to about 1.4 inches. In still further embodiments, a generally annular-shaped or other massaging surface will generally have widths in the range of about 0.4 inches to about 1.0 inches. In even further embodiments, a generally annular-shaped or other massaging surface will generally have widths in the range of about 0.4 inches to about 0.8 inches. In still further embodiments, a generally annular-shaped or other massaging surface will generally have widths in the range of about 0.5 inches to about 0.7 inches.

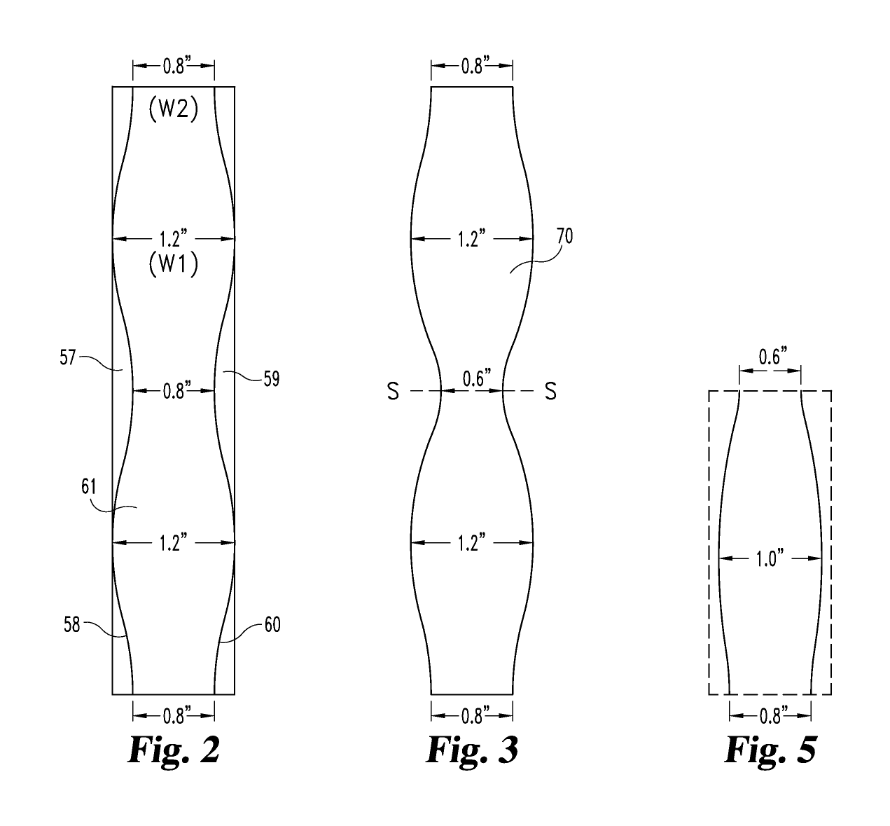

FIG. 3 provides a diagram representing another illustrative disk-shaped member, and it shows how the member can have a generally annular-shaped outer surface 70 whose width varies around the disk-shaped member. In this instance (from the top of the diagram moving down), the width increases from 0.8 inches to 1.2 inches, then decreases from 1.2 inches to 0.6 inches, then increases from 0.6 inches to 1.2 inches, and then finally decreases from 1.2 inches back to 0.8 inches at the bottom of the diagram which represents one full revolution of the disk-shaped member.

The generally annular massaging surface represented by the diagram of FIG. 3 has greater variation in its width around the disk-shaped member as compared to the massaging surface represented by FIG. 2, and by this illustrative comparison, it should become very apparent that the width of a massaging surface (e.g., a generally annular-shaped outer surface) can vary in any suitable fashion and to any suitable degree around an inventive disk-shaped member, and that such variations can produce a large variety of massaging surface shapes and configurations. Illustratively, along a particular stretch of a disk-shaped member, the width of an outer massaging surface can vary at a constant or non-constant rate. Also, while the edges of the generally annular massaging surfaces represented by the diagrams of FIGS. 2 and 3 move back and forth in an undulating fashion around the disk-shaped member, it should be understood that such inventive massage surfaces can exhibit a variety of curvilinear and/or rectilinear edge shapes. Illustratively, when viewed in diagram form as in FIG. 2, an edge of a generally annular massaging surface could extend in a generally straight fashion along a particular stretch of the disk-shaped member, for example, between a maximum width and a minimum width such as W1 and W2 in FIG. 2.

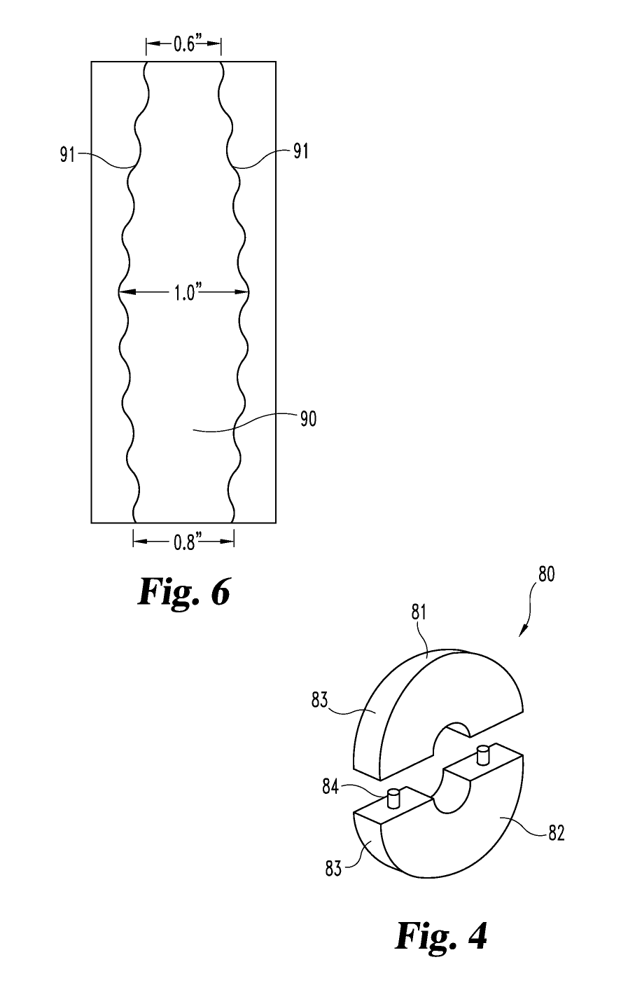

FIG. 4 shows an exploded view of a disk-shaped member 80 according to another embodiment of the present invention. Member 80 includes a top piece 81 and a bottom piece 82 which can be combined to form the overall disk-shaped member which will have an outer annular surface 83. Alternative designs will have left and right side pieces when viewed from the front that will be glued or otherwise joined together to form an overall disk-shaped member. While many techniques for permanently or temporarily attaching the two pieces together are contemplated, in this particular embodiment, top piece 81 provides holes or slots (hidden in FIG. 4) into which pegs 84 of the bottom piece 82 can be received. In some forms, a pressure tight fit will sufficiently hold the pieces together during normal use, yet allow disengagement of the pieces when desired. Referring again to FIG. 3, an optional separation line S has been included in the diagram to show how two separate pieces (like those shown in FIG. 4) might be brought together to form the annular-shaped outer surface 70 in FIG. 3.

Thus, with such configurations where multiple separate pieces can be combined to form a single disk-shaped member, it is possible to provide kits that include a collection of differently-shaped pieces that can be interchanged between or among each other to allow a user to construct a variety of differently-shaped disk-shaped members. Further, when an inventive disk or disk-like member is constructed by combining two or more constituent components, any one of the components may be similar to or different than any other device component in terms of its shape, size, material(s) of construction, rigidity, surface characteristics (e.g., including projections) and/or other properties. Illustratively, two device components might be formed from essentially the same or different material(s), for example, one component being more rigid than the other.

Illustratively, a piece represented by the diagram in FIG. 5 could be substituted for the piece represented by the bottom half of the diagram of FIG. 3. Accordingly, this FIG. 5 piece having an outer surface with a 1.0 inch width (a maximum width for that individual piece) could be combined with the piece represented by the top half of the diagram of FIG. 3 to form a new overall device having an outer surface offering 0.6 inch, 0.8 inch, 1.0 inch and 1.2 inch intermediate widths around the single disk.

FIG. 6 provides a diagram representing another piece that could be substituted for the piece represented by the bottom half of the diagram of FIG. 3. While the width of the outer surface 90 (moving from the top of the diagram to the bottom of the diagram) generally increases from 0.6 inches to 1.0 inches, and then generally decreases from 1.0 inches to 0.8 inches, within these general changes in width, the edges 91 of the outer surface oscillate. Thus, in this particular design, smaller undulations occur within the larger undulations around the disk-shaped member. Among other things, this diagram shows how an edge of an outer annular surface can have a general direction of travel yet present a particular edge shape or contour within that general overall direction of travel. Various curvilinear and rectilinear edge contours and shapes are contemplated in this regard.

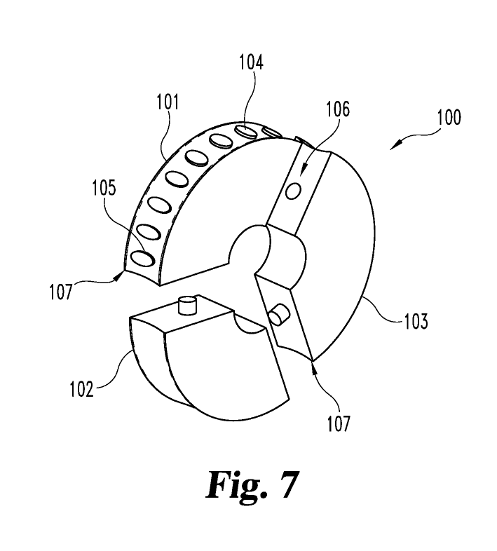

FIG. 7 shows an exploded view of a disk-shaped member 100 according to another embodiment of the present invention. Member 100 includes a first piece 101, a second piece 102 and a third piece 103 which can be combined to form the overall disk-shaped member which will have an outer annular surface 104. Optionally, a plurality of raised lateral ridges 105 can be spaced along all or part of the outer annular surface as shown with respect to first piece 101. For connecting purposes, in this specific illustrative embodiment, a hole (e.g., hole 106 in third piece 103) can be provided in any one of the pieces for receiving a peg from another piece.

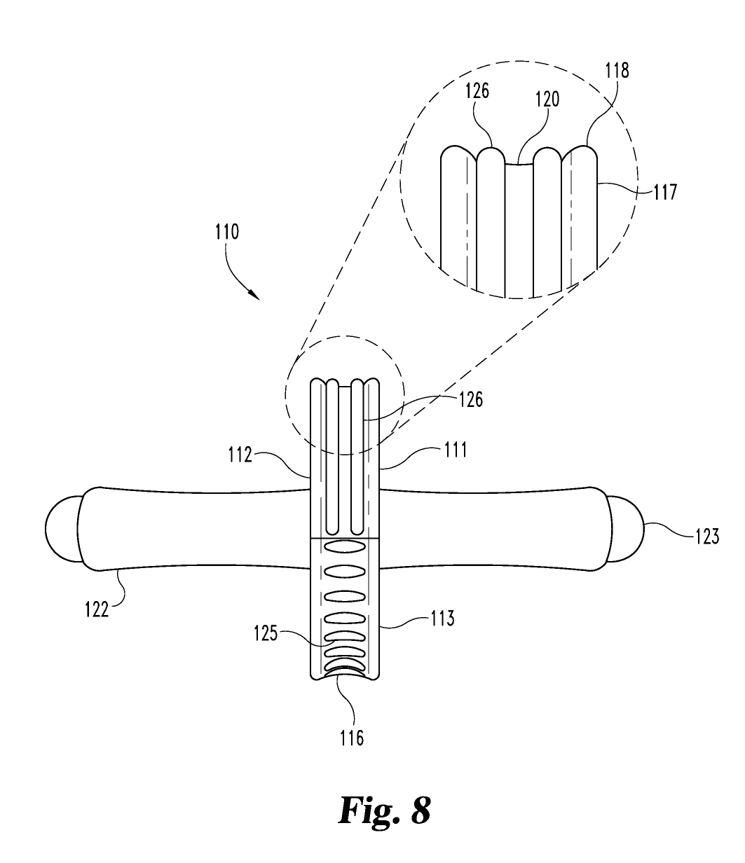

FIG. 8 provides a front view of a massage device 110 according to another embodiment of the present invention. Device 110 includes a composite disk-shaped member 111. Member 111 includes a first piece 112, a second piece 113 and a third piece 114 (the third piece not visible from this view) that have been separately-formed but later joined together to form the overall disk-shaped member. When assembled, member 111 includes a generally annular exterior surface or region 116 that extends around the disk-shaped member. Outer ridge or ridge-like projections 117 run in a generally longitudinal direction around the annular exterior region, and when the device is viewed from the front as in FIG. 8, the outer ridges provide opposing side edges 118 of the annular exterior region. Each of the three pieces contributes to this feature. A concave surface 120 extends between the opposing side edges 118 in a generally lateral direction across the annular exterior region 116. Also, while in this specific illustrative embodiment the distance across the member, i.e., between the opposing side edges, remains generally constant around the annular exterior region, it need not. The general width of the annular exterior region can vary around the disk-shaped member as is described with respect to some of the other embodiments disclosed herein. Additionally, disk-shaped member 111 can be rotatable or non-rotatable about axis member 122. Axis member 122 provides opposing handles for the device and can be of any suitable construction. In this particular case, the handles have an exterior foam covering or coating and include rounded ends 123 that are rigid or semi-rigid and are generally fixed in place relative to the handles.

As discussed elsewhere herein, when a disk-shaped member includes multiple constituent pieces (e.g., left-right mating pieces, top-bottom halves, designs that include three or more “pieces of a pie”, etc.) that make up a generally annular exterior surface or region, any two pieces can be essentially identical or they can have one or more similar and/or dissimilar features. In this regard, continuing with FIG. 8, first piece 112 includes two longitudinally-extending projections 126 which are spaced apart along its portion of the annular exterior region 116. Such longitudinally-extending projections can have any suitable shape and can be present in any suitable number (e.g., one or more) along an exterior region. Second piece 113 includes a plurality of laterally-extending (e.g., oval shaped) projections 125 spaced apart along its portion of the annular exterior region. Such laterally-extending projections can have any suitable shape and can be present in any suitable number along an exterior region. All of these projections project from concave surface 120 and reside between opposing side edges 118. Third piece 114, while having the outer ridges providing opposing side edges 118, has no other projections projecting from the concave surface. Any combination of these or other constituent pieces can be used to form an inventive disk-shaped member. In alternative constructions, an assembled disk-shaped member will include three constituent pieces that are all similar to first piece 112, as just one example. In this regard, the longitudinally-extending projections 126 will extend around the entirety of the disk-shaped member 111. In another specific alternative construction, an assembled disk-shaped member will include three constituent pieces that are all similar to second piece 102 of FIG. 7, i.e., where the outer annular surface has pointed or ridge-like opposing side edges by virtue of the surface's concavity but otherwise has no projections projecting from the outer annular surface. Again, any of these or other inventive constructions can exhibit an annular exterior region or surface of constant or variable width around the disk-shaped member.

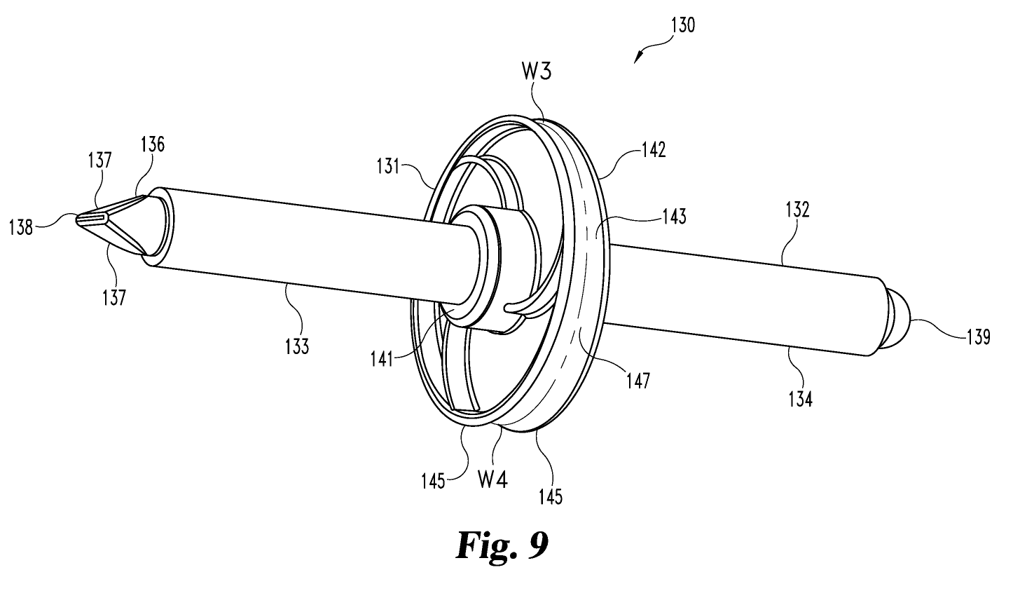

FIG. 9 provides a perspective view of a massage device 130 according to another embodiment of the present invention. Device 130 includes a generally disk-shaped member 131 that is rotatable about an axis member 132. Axis member 132 provides a left handle 133 and a right handle 134. Left handle includes a tapered end component 136 that includes opposing generally planar surfaces 137 that are separated by a generally straight edge 138 at the end of the device. Right handle 134 includes a generally rounded end 139. While shaped ends of this sort are optional, they can be particularly useful for trigger point therapy and cross friction massage. Disk-shaped member 131 includes an inner hub member 141 that accommodates axis member 132 and allows rotation. Disk-shaped member 131 also includes a peripheral massage component 142 that provides a generally annular exterior surface 143 that extends around the disk-shaped member. Annular exterior surface 143 has opposing, circumferential side edges 145. The width of the annular exterior surface 143 changes at a generally constant rate around the disk-shaped member 131 where the disk-shaped member is bilaterally symmetrical as viewed from the front. In particular, in this illustrative embodiment, the width of the annular exterior surface 143 attains a maximum width W4 (e.g., in the range of about 0.6 inches to about 1.0 inches) and a minimum width W3 (e.g., in the range of about 0.2 inches to about 0.5 inches) one time each during one full revolution around the disk-shaped member. While not necessary to broader aspects of the invention, in this instance, the annular exterior surface 143 exhibits a concave shape 147 in a lateral direction (i.e., left to right when viewed from the front) across the disk-shaped member 131. Alternatively, the annular exterior surface might exhibit a convex or flat shape in a lateral direction across the disk-shaped member 131, or any number of other suitable curvilinear or rectilinear shapes in this regard.

All publications and patent applications cited in this specification are herein incorporated by reference as if each individual publication or patent application were specifically and individually indicated to be incorporated by reference. Further, any theory, mechanism of operation, proof, or finding stated herein is meant to further enhance understanding of the present invention, and is not intended to limit the present invention in any way to such theory, mechanism of operation, proof, or finding. While the invention has been illustrated and described in detail in the drawings and foregoing description, the same is to be considered as illustrative and not restrictive in character, it being understood that only selected embodiments have been shown and described and that all equivalents, changes, and modifications that come within the spirit of the inventions as defined herein or by the following claims are desired to be protected.

What is claimed is:

1. A massage device, comprising:
a disk-shaped member for contacting and massaging the body of a massage recipient, the disk-shaped member having an exterior that includes:
a left side face having a perimeter;
a right side face having a perimeter, said right side face substantially opposite said left side face; and
an intermediate, annular surface located generally between the perimeter of said left side face and the perimeter of said right side face,
wherein the width of said intermediate surface varies around the disk-shaped member.

2. The massage device of claim 1, wherein the perimeter of said left side face opposes the perimeter of said right side face in a symmetrical fashion around said disk-shaped member.

3. The massage device of claim 1, further comprising at least a first handle extending from the left side face of the disk-shaped member.

4. The massage device of claim 3, further comprising a second handle extending from the right side face of the disk-shaped member.

5. The massage device of claim 4, wherein said disk-shaped member is rotatable with respect to said first handle and said second handle.

6. The massage device of claim 1, wherein the width of the intermediate surface varies at a constant rate around a partial segment of the disk-shaped member.

7. The massage device of claim 1, wherein the width of the intermediate surface does not vary at a constant rate around a partial segment of the disk-shaped member.

8. A massage device, comprising:
a disk-shaped member that includes a generally annular exterior surface for contacting and massaging the body of a massage recipient, the annular exterior surface having a left circumferential side edge and a right circumferential side edge, wherein the distance between said left circumferential side edge and said right circumferential side edge varies around the annular exterior surface.

9. The massage device of claim 8, wherein the distance between the left circumferential side edge and the right circumferential side edge changes from a first distance to a second distance and back to said first distance at least once around the disk-shaped member.

10. The massage device of claim 9, wherein said first distance is a maximum distance between said left circumferential side edge and said right circumferential side edge and said second distance is a minimum distance between said left circumferential side edge and said right circumferential side edge.

11. The massage device of claim 8, wherein said annular exterior surface is convexly shaped in a lateral direction across the disk-shaped member.

12. The massage device of claim 8, wherein the disk-shaped member includes at least one projection extending from said annular exterior surface.

13. The massage device of claim 12, wherein the at least one projection includes a circumferential ridge extending around the disk-shaped member between the left circumferential side edge and the right circumferential side edge of said annular exterior surface.

14. The massage device of claim 8, wherein at least one of said left circumferential side edge and said right circumferential side edge extends around the disk-shaped member in an undulating fashion.

15. The massage device of claim 14, wherein said left circumferential side edge and said right circumferential side edge undulate in a symmetrical fashion around the disk-shaped member.

16. The massage device of claim 8, wherein said left circumferential side edge and said right circumferential side edge undulate one or more times around the disk-shaped member between a maximum width of the annular exterior surface and a minimum width of the annular exterior surface.

17. The massage device of claim 8, wherein said annular exterior surface is concavely shaped in a lateral direction across the disk-shaped member.

18. A massage device, comprising:
a generally disk-shaped member that includes an outer annular surface for contacting and massaging the body of a massage recipient, the outer annular surface having a variable width around the disk-shaped member.

19. The massage device of claim 18, wherein said outer annular surface is provided by a single device component.

20. The massage device of claim 18, wherein said outer annular surface is provided by two or more constituent components that have been joined together to form said outer annular surface.
